(19) United States
(12) Patent Application Publication
(10) Pub. No.: US 2010/0060082 A1
(43) Pub. Date: Mar. 11, 2010

(54) ELECTRONIC DEVICE

(76) Inventor: De Lu QU, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/556,602

(22) Filed: Sep. 10, 2009

(30) Foreign Application Priority Data
Sep. 11, 2008 (JP) 2008-233196

(51) Int. Cl. H02J 3/00

(52) U.S. Cl. 307/72

(57) ABSTRACT

A digital camera includes: a battery installation part connectable to either an AC adapter or a battery; a mechanical shutter and a diaphragm; and a controller for supplying, to the mechanical shutter and the diaphragm, power from the AC adapter or battery that is connected to the battery installation part. The controller monitors a voltage output through the battery installation part during the power supply to the mechanical shutter and the diaphragm, and determines whether or not the AC adapter is connected to the battery installation part in accordance with the behavior of the monitored voltage changes.

### CROSS REFERENCE TO RELATED APPLICATION

This application claims priority to Japanese Patent Application No. 2008-233196 filed on Sep. 11, 2008, the disclosure of which including the specification, the drawings, and the claims is hereby incorporated by reference in its entirety.

### BACKGROUND OF THE INVENTION

1. Field of the Invention

The present invention relates to electronic devices having a connection part selectively connectable to either an alternating current (AC) adapter connected to a non-battery power source or a battery power source.

2. Description of the Related Art

Japanese Laid-Open Publication No. 3-182177 describes one type of conventional electronic device. The electronic device according to Japanese Laid-Open Publication No. 3-182177 is configured so as to be selectively connectable to either an AC adapter connected to a non-battery power source or a battery (i.e., a battery power source). This electronic device is sometimes required to determine whether the connected power source is the non-battery power source or the battery power source. For example, when the battery power source is connected, the electronic device needs to inform the user of the residual quantity of the battery. Thus, it is necessary to determine whether the power source connected to the electronic device is either the non-battery power source or the battery power source.

To that end, the electronic device of Japanese Laid-Open Publication No. 3-182177 determines the amount of change in internal electromotive voltage of the power source during a given period of time, and compares the amount of change with a threshold value stored in advance. When the amount of change is higher than the threshold value, the electronic device determines that the power source is the battery.

### SUMMARY OF THE INVENTION

However, the electronic device described in Japanese Laid-Open Publication No. 3-182177 is required to store in advance the threshold voltage on the basis of which the determination is made.

In addition, the output voltage of the battery varies due to ambient temperature, internal resistance, the material of the battery, and other factors. That is, the amount of voltage change used to determine the power source varies due to environmental factors and the state of the battery. Consequently, the accuracy of the determination decreases in the electronic device that is configured to determine the power source according to the amount of actually measured voltage change.

In view of the above, the techniques disclosed herein have been developed. Therefore, it is an object of the present invention to provide an electronic device that has a connection part selectively connectable to either an AC adapter connected to a non-battery power source or a battery power source and that is capable of determining the connected power source with higher accuracy.

An electronic device disclosed herein includes a connection part which may be selectively connected to either an AC adapter connected to a non-battery power source or a battery power source. The electronic device includes: an operating member; a supply section configured to supply, to the operating member, power output through the connection part from either the AC adapter or the battery power source which is connected to the connection part; a voltage monitoring section configured to monitor a voltage output through the connection part when the supply section supplies the power to the operating member; and a determination section configured to determine whether the AC adapter or the battery power source is connected to the connection part, in accordance with a behavior of the voltage changes monitored by the voltage monitoring section. Here, “a behavior of the voltage changes” means how the voltage changes, for example, tendency of the change, e.g., whether the change exhibits an increase or a decrease, the degree of the inclination of the change, whether the voltage changes linearly or in a curve, and the like.

The electronic device thus configured is capable of determining the connected power source in accordance with the behavior of the output voltage changes of the power source.

According to the present invention, it is possible to determine the power source connected to the connection part with higher accuracy by determining whether the AC adapter or the battery is connected to the connection part in accordance with the behavior of the output voltage changes of the connection part.

### BRIEF DESCRIPTION OF THE DRAWINGS

FIG. 1 is a perspective view of a digital camera according to an example embodiment.

FIG. 2 is an explanatory block diagram of the configuration of the digital camera.

FIGS. 3(A) and 3(B) are explanatory graphs each illustrating changes in voltage output from a power source when power is supplied to operating members; FIG. 3(A) shows a case in which an AC adapter is the power source, and FIG. 3(B) shows a case in which a battery is the power source.

FIG. 4 is a flowchart of an example operation of the digital camera.

### DETAILED DESCRIPTION OF THE INVENTION

### Embodiment

Hereinafter, an electronic device according to an example embodiment will be described. In this embodiment, a digital camera 10 is employed as the electronic device. The configuration of the digital camera 10 will be described below with reference to the accompanying drawings. In this embodiment, an example case in which a primary battery is used as the battery will be described.

(1. Configuration)

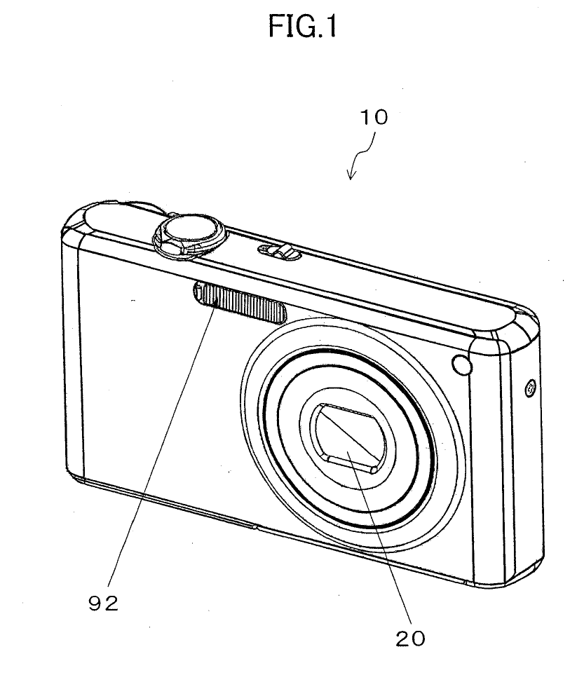

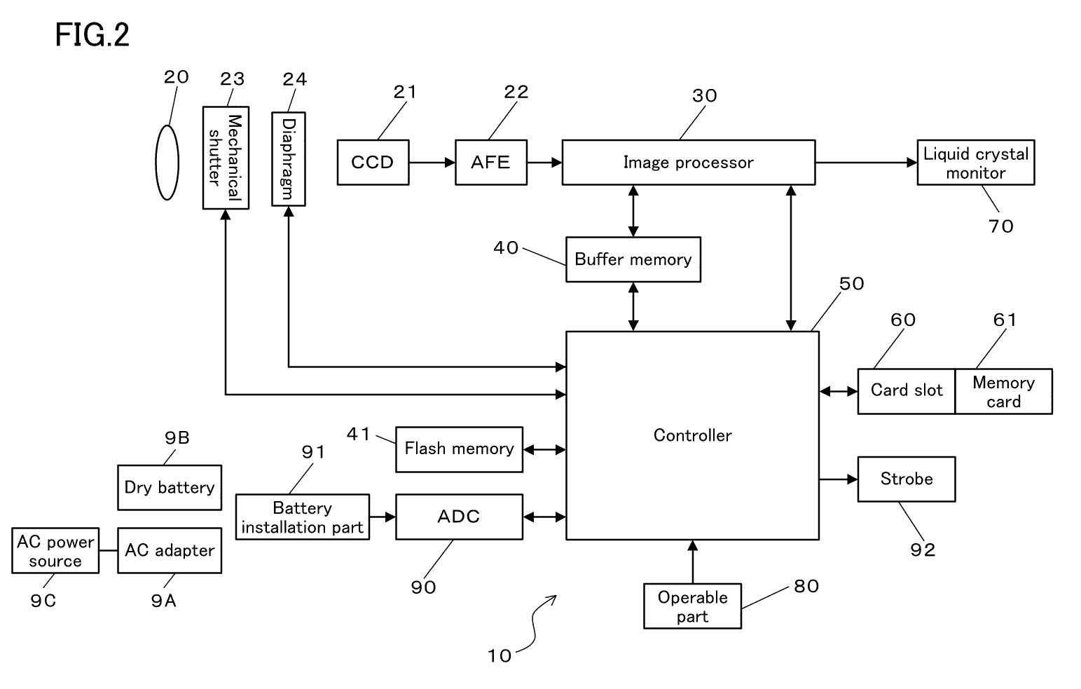

FIG. 1 is a perspective view of the digital camera 10 according to the example embodiment. FIG. 2 is a block diagram illustrating the configuration of the digital camera 10 of the example embodiment.

The digital camera 10 includes an optical system 20, a charge-coupled device (CCD) image sensor 21, an analog front end (AFE) 22, a mechanical shutter 23, a diaphragm 24, an image processor 30, a buffer memory 40, a flash memory 41, a controller 50, a card slot 60, a liquid crystal monitor 70, an operable part 80, an analog-to-digital (AD) converter 90, a battery installation part 91, and a strobe 92.

The optical system 20 collects an optical signal from an object to form an image of the object on the CCD image sensor 21. The CCD image sensor 21 is an imaging device for capturing an image of an object and generating image data. As the imaging device, a CMOS image sensor or other sensor may also be used instead of the CCD image sensor 21. The AFE 22 is composed of a correlated double sampling circuit (CDS), an AD converter, and other elements not shown. The AD converter converts image data generated by the CCD image sensor 21 to digital data.

In accordance with control by the controller 50, the mechanical shutter 23 adjusts, in terms of time, the amount of light applied to the CCD image sensor 21. The diaphragm 24 adjusts the amount of light that passes through the optical system 20 in accordance with control by the controller 50. The mechanical shutter 23 and the diaphragm 24 are operated selectively during an operation of the digital camera 10. The mechanical shutter 23 and the diaphragm 24 are examples of an operating member and a first operating member as referred to herein.

The image processor 30 performs given processing on image data input from the CCD image sensor 21 through the AFE 22. The given processing includes, but is not limited to, gamma transformation, YC conversion, electronic zooming processing, compression processing, and decompression processing. The image processor 30 is capable of outputting digitized image data to the liquid crystal monitor 70. The image processor 30 is also able to output an image stored in the buffer memory 40 to the liquid crystal monitor 70.

The buffer memory 40 serves as a work memory when the image processor 30 performs image processing and when the controller 50 performs control processing. The buffer memory 40 can be realized using dynamic random access memory (DRAM), for example.

The flash memory 41 is used as a built-in memory. The flash memory 41 is capable of storing not only image data but also programs, set values, and the like used for control by the controller 50.

The controller 50 controls each component in the digital camera 10. The controller 50 may be realized using a microcomputer or a hard-wired circuit. That is, the controller 50 may be any device capable of controlling the electronic device in which the controller 50 is provided. The controller 50 is an example of supply section, voltage monitoring section, determination section, first supply section, second supply section, and control section as referred to herein. In this embodiment, a single controller 50 performs functions of these sections such as the supply section. Nevertheless, those functions may be performed by multiple CPUs and circuits, or a different CPU or circuit may be provided for each function.

The card slot 60 is a slot for inserting and removing the memory card 61. The card slot 60 may also have the function of controlling the memory card 61. The memory card 61 includes flash memory or the like therein. The memory card 61 is capable of storing captured image data and other data.

The liquid crystal monitor 70 displays images showing image data and a variety of settings of the digital camera 10. In place of the liquid crystal monitor 70, an organic EL display may be employed.

The operable part 80 is used herein as a general name for components in the digital camera 10 that are operable by users. The operable part 80 may include a cross key and a push button, for example, and when the liquid crystal monitor 70 is composed of a touch panel, that touch panel and the like.

The battery installation part 91 is configured so as to be selectively connectable to either an AC adapter 9A or a dry battery 9B (hereinafter referred to simply as a “battery”). The AC adapter 9A is connected to the battery installation part 91 through a direct current (DC) coupler (not shown). The AC adapter 9A is also connected to an AC power source 9C. In other words, the AC power source 9C is indirectly connected to the battery installation part 91 through the AC adapter 9A. The AC adapter 9A, which is a constant-voltage AC adapter, converts an AC voltage from the AC power source 9C to a DC voltage having a given voltage value, and outputs the DC voltage. The AC power source 9C is a domestic power source, for example. In this manner, the AC adapter 9A converts an AC voltage from a domestic power source to a DC voltage to supply the DC voltage to the digital camera 10. The battery installation part 91 is an example of a connection part, the AC power source 9C is an example of a non-battery power source, and the battery 9B is an example of a battery power source as referred to herein.

The AD converter (ADC) 90 converts an analog voltage supplied from the AC adapter 9A or the battery 9B to the digital camera 10 into a digital voltage, and supplies the digital voltage to the controller 50.

In this embodiment, the controller 50 is configured so as to monitor the voltage output from the AC adapter 9A or the battery 9B to the digital camera 10 based on the input from the AD converter 90. That is, the controller 50 samples the digital voltage input from the AD converter 90 every 1/20 millisecond (msec.), for example. The sampled voltage is stored in the buffer memory 40, for example.

The strobe 92 applies light to an object in accordance with control by the controller 50. The strobe 92 is composed of a xenon lamp, a capacitor, and other elements. The capacitor is capable of retaining electric charge for light emission. The strobe 92 is an example of a second operating member as referred to herein.

(2. Operation)

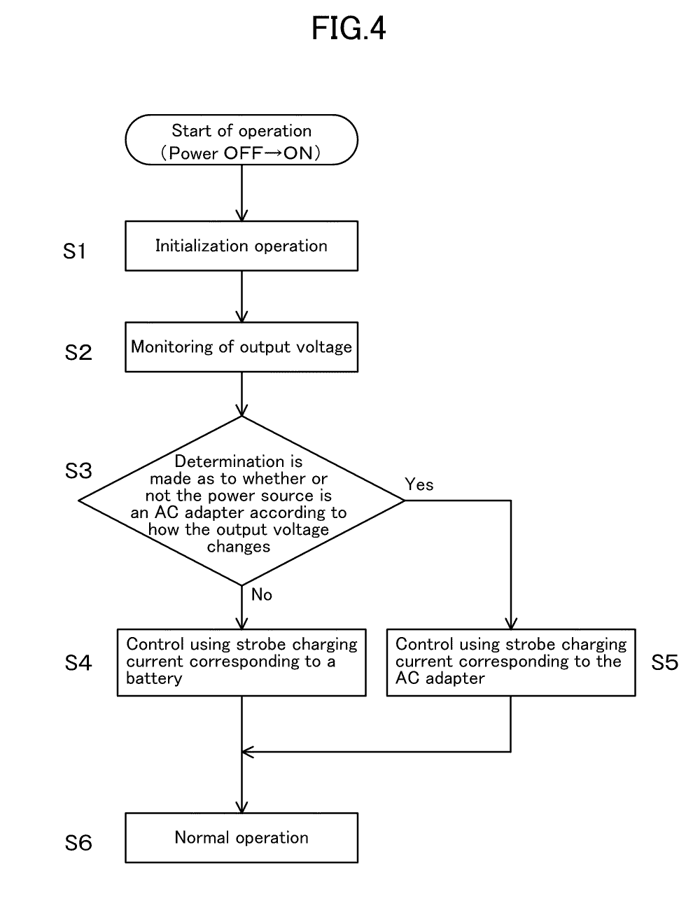

An example operation of the digital camera 10 thus configured will be described with reference to FIG. 4. In the example operation, a description will be made of an operation performed to determine whether the power source connected to the battery installation part 91 is the AC power source 9C or the battery 9B, that is, whether the AC adapter 9A or the battery 9B is connected to the battery installation part 91.

When powered on from the off state, the digital camera 10 (the controller 50) performs the following operation.

First, for initialization operation, the controller 50 supplies an excitation voltage to the mechanical shutter 23 and the diaphragm 24 (S1). This causes the mechanical shutter 23 and the diaphragm 24 to move to their initial positions. When powered off from the on state, the digital camera 10 terminates operation after first making the mechanical shutter 23 and the diaphragm 24, for example, move to their initial positions (e.g., with the mechanical shutter 23 being open). However, when the digital camera 10 is in the powered-off state, the respective states of the mechanical shutter 23 and diaphragm 24 may be changed due to an impact shock and the like. Thus, when powered on (i.e., upon startup), the digital camera 10 is required to move the mechanical shutter 23 and the diaphragm 24 to their initial positions. Furthermore, if the digital camera 10 is equipped with a collapsible lens or the like, for example, the lens is collapsed when the digital camera 10 is powered off. Therefore, when powered on, the digital camera 10 needs to move each part of the collapsible lens to the initial position. This enables the digital camera 10 to smoothly move on to a photographing operation after power is turned on.

While supplying an excitation voltage to the mechanical shutter 23 and the diaphragm 24, the controller 50 samples a voltage input from the power source by way of the output of the AD converter 90 (S2).

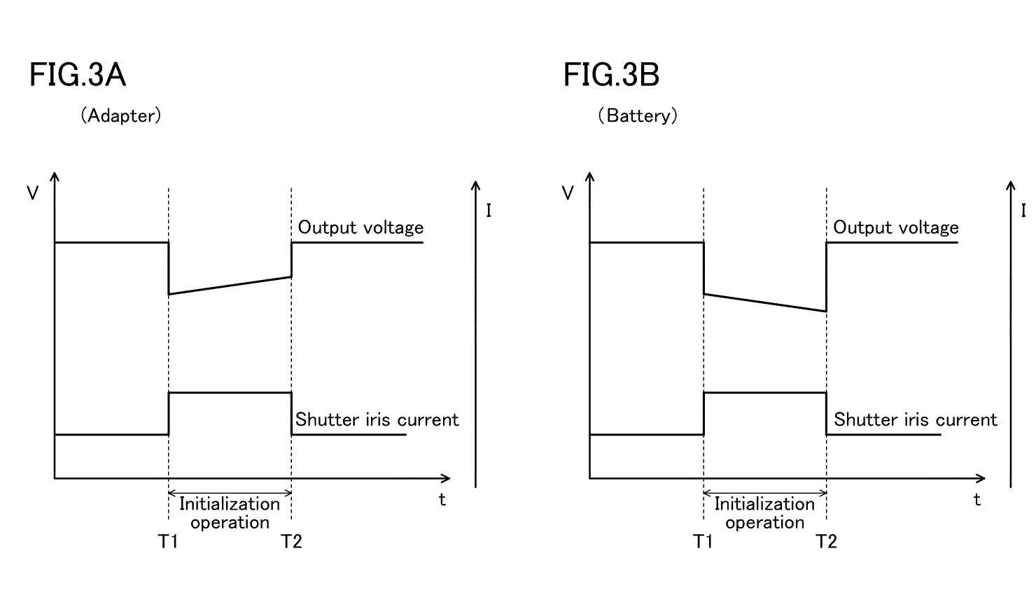

The controller 50 determines whether the AC adapter 9A or the battery 9B is connected to the battery installation part 91 according to a difference in the waveform of the sampled voltage, that is, the behavior of the voltage changes (S3). A detailed description of how the controller 50 determines the power source will be provided with reference to FIGS. 3(A) and 3(B). FIG. 3(A) shows changes in output voltage from the AC adapter 9A when the AC adapter 9A is connected to the battery installation part 91. FIG. 3(B) shows changes in output voltage from the battery 9B when the battery 9B is connected to the battery installation part 91. The upper waveforms in FIGS. 3(A) and 3(B) represent the voltages output when initialization operation is performed on the mechanical shutter 23 and the diaphragm 24. The lower waveforms in the FIGS. 3(A) and 3(B) represent the currents (the loads with respect to the power sources) output when the initialization operation is performed on the mechanical shutter 23 and the diaphragm 24. FIGS. 3(A) and 3(B) show that the initialization operation is performed on the mechanical shutter 23 and the like during the period of time from a first time T1 to a second time T2.

First, a current is supplied to the mechanical shutter 23 and the diaphragm 24. That is, a load is connected to the power source. As a result, the voltage output from the AC adapter 9A and the battery 9B drops temporarily. Specifically, the AC adapter 9A and the battery 9B have resistive components (in particular, the battery 9B has internal resistance) such as wiring resistance or the like. Therefore, as the output current is increased, a voltage drop due to these resistive components increases, causing the output voltage to decrease.

The AC adapter 9A, which has a constant voltage circuit or the like therein, functions to stabilize the output voltage. Thus, when the AC adapter 9A is connected to the battery installation part 91, the decreased output voltage gradually increases toward a given voltage level. On the other hand, the battery 9B does not include a constant voltage circuit or the like, and if the battery 9B is continuously used, the internal resistance thereof increases with time. Due to these reasons, the output voltage from the battery 9B changes very little from the lowered level described above, or decreases further. The controller 50 utilizes those characteristics to determine whether the AC adapter 9A or the battery 9B is connected to the battery installation part 91, that is, whether the power source is the AC power source 9C or the battery 9B.

Specifically, the controller 50 determines the power source during startup operation (i.e., initialization operation) of the digital camera 10. During startup operation in which the controller 50 supplies power to the mechanical shutter 23 and the diaphragm 24, the controller 50 compares the output voltage (i.e., the voltage output through the battery installation part 91) at the first time T1 with the output voltage at the second time T2 (T2>T1), thereby determining the behavior of the output voltage changes. In this embodiment, the first and second times T1 and T2 are respectively the times when the power supply to the mechanical shutter 23 and the diaphragm 24 is started and stopped during startup operation. Then, the controller 50 determines whether or not the relationship “the output voltage at the first time T1<the output voltage at the second time T2” is satisfied. To be specific, when the relationship “the output voltage at the first time T1<the output voltage at the second time T2” is satisfied, the controller 50 determines that the power source is the AC power source 9C connected through the AC adapter 9A because the behavior of the output voltage changes exhibits an increase. On the other hand, when the relationship “the output voltage at the first time T1<the output voltage at the second time T2” is not satisfied, that is, when the relationship “the voltage at the first time T1≧the voltage at the second time T2” is satisfied, the controller 50 determines that the power source is not the AC power source 9C connected through the AC adapter 9A. Rather, the power source is determined to be the battery 9B, because the behavior of the output voltage changes does not exhibit an increase. In this manner, the controller 50 determines whether the AC adapter 9A or the battery 9B is connected to the battery installation part 91, that is, whether the power source is the AC power source 9C or the battery 9B, in accordance with the behavior of the output voltage changes of the battery installation part 91 during power supply to operating members such as the mechanical shutter 23 or diaphragm 24.

In this embodiment, the voltages at the first and second times T1 and T2 are compared to determine the power source. However, the invention is not limited thereto. For example, the first and second times T1 and T2 are not limited to the times when the power supply to the mechanical shutter 23 and the like is started and stopped, but may correspond to the timing of any other events performed during startup operation. Furthermore, the voltages to be compared do not need to be respective pieces of data obtained at the first and second times T1 and T2. For example, during startup operation, the average value of voltages sampled from a first given period of time and the average value of voltages sampled from a second given period of time after the first given time period may be compared. By using such average values, effects of errors such as noise are reduced.

In this manner, the controller 50 determines whether the power source connected to the battery installation part 91 is the AC power source 9C through the AC adapter 9A or the battery 9B. Thereafter, the controller 50 performs a variety of operations; in performing operations in which processing needs to be changed depending on the power source, the controller 50 executes the processing differently according to the power source.

For example, as shown in FIG. 4, upon determination that the connected power source is not the AC power source 9C through the AC adapter 9A, but is the battery 9B, the controller 50 sets the charging current of the strobe 92 to a value corresponding to the battery 9B (S4). On the other hand, upon determination that the connected power source is the AC power source 9C through the AC adapter 9A, the controller 50 sets the charging current of the strobe 92 to a value corresponding to the AC power source 9C, that is, a value corresponding to the rating of the AC adapter 9A (S5). Specifically, in terms of reducing the time required for preparation for flash photography, the charging time of the strobe 92 is preferably short. To that end, it is desired for the charging current of the strobe 92 to be large. However, in the case of the power source connected through the AC adapter 9A, if the charging current is increased excessively, the rating may be exceeded. In view of this, in this embodiment, when the power source is the battery 9B, the charging current of the strobe 92 is set to a relatively large value corresponding to the battery 9B for early completion of charging of the strobe 92. On the other hand, when the power source is the AC power source 9C connected through the AC adapter 9A, the charging current of the strobe 92 is set to a value corresponding to the rating of the AC adapter 9A so as to prevent exceeding the rating of the AC adapter 9A. If the rating of the AC adapter 9A has a relatively large capacity, it is desired that the charging current of the strobe 92 be set to a large value within the rating so as to charge the strobe 92 quickly. In this way, the controller 50 determines that the power source is the one connected through the AC adapter 9A, and performs control with consideration given to the rating of the AC adapter 9A.

After completion of the above-described operation in Step S4 or S5, the controller 50 moves on to normal operation of the digital camera 10 (S6). The normal operation of the digital camera 10 is not limited to any particular operation. For example, the normal operation includes a photographing mode in which the digital camera 10 is put in a photographable state, a reproduction mode in which photographed images are reproduced, and other modes.

In FIG. 4, the control of the charging current of the strobe 92 is described as an operation in which processing is changed depending on the power source, however, such operation is not limited thereto. For example, operations in which processing is changed depending on the power source include display of the residual quantity of the battery and the like. To be specific, upon determination that the power source connected to the battery installation part 91 is the battery 9B, the controller 50 displays the residual quantity of the battery on the liquid crystal monitor 70. On the other hand, upon the determination that the power source connected to the battery installation part 91 is the AC power source 9C, the controller 50 does not display the residual quantity of the battery or displays the connection of the AC adapter 9A on the liquid crystal monitor 70.

Another operation in which processing is changed depending on the power source is control for executing a demonstration mode. Specifically, the digital camera 10 may be displayed on a store shelf for demonstration purposes. In that case, the digital camera 10 is preferably set to a demonstration mode in which a demonstration is performed on the liquid crystal monitor 70. When the digital camera 10 is displayed on a store shelf as in this case, the AC adapter 9A is connected. Therefore, upon determination that the AC adapter 9A is connected, the digital camera 10 is automatically set to the demonstration mode. On the other hand, upon determination that the battery 9B is connected, the digital camera 10 automatically cancels the demonstration mode. This allows the digital camera 10 to be automatically set to the demonstration mode when the digital camera 10 is displayed on a store shelf. Nevertheless, even when the AC adapter 9A is connected, the digital camera 10 may not be displayed on a store shelf (i.e., the digital camera 10 may be used by a user). Therefore, the automatic setting of the demonstration mode according to whether the AC adapter 9A or the battery 9B is connected may be user-settable.

(3. Summary)

The digital camera 10 in the exemplary embodiment includes: the battery installation part 91 connectable to either the AC adapter 9A or the battery 9B; the mechanical shutter 23 and the diaphragm 24; and the controller 50. The controller 50 supplies power (passes a current) from the AC adapter 9A or battery 9B connected to the battery installation part 91 to the mechanical shutter 23 and the diaphragm 24. At this time, the controller 50 monitors the voltage output from the AC adapter 9A or battery 9B connected to the battery installation part 91, and determines whether the AC adapter 9A or the battery 9B is connected to the battery installation part 91 according to the behavior of the monitored voltage changes.

As in this case, when the power source connected to the battery installation part 91 is determined according to the behavior of the output voltage changes of the battery installation part 91, the accuracy of the determination increases. Specifically, the voltage of the battery 9B varies depending on the environment in which the battery 9B is used and the state of the battery. In such a configuration as described in Japanese Laid-Open Publication No. 3-182177, in which a power source is determined by comparing the actual measurement value of the amount of temporal change in voltage output from the power source with a threshold value stored in advance, the accuracy of the determination decreases. This is because the actual measured value varies, while the threshold value is constant. In contrast, the relative behavior of the output voltage changes of the AC adapter 9A and the behavior the output voltage changes of the battery 9B do not vary due to the environment in which the AC adapter 9A and the battery 9B are used and the states of the power sources; the output voltage of the AC adapter 9A always temporarily drops due to the connection of a load, and then increases gradually, while the output voltage of the battery 9B always temporarily drops because of the connection of a load, and then decreases gradually or changes very little. Therefore, even in a situation in which the output voltage varies due to the usage environment and the state of the power source, the accuracy of determination is increased by determining the power source in accordance with how the output voltage changes instead of how much the output voltage changes.

Furthermore, in this embodiment, it is possible to further increase the determination accuracy by determining the power source on the basis of the behavior of the output voltage changes of the AC adapter 9A. Specifically, the behavior of the output voltage changes of the AC adapter 9A always exhibits such an increase as to bring the voltage back to a given voltage level. On the other hand, the behavior of the output voltage changes of the battery 9B exhibits a decrease. However, the degree of the decrease changes depending on the environment in which the battery 9B is used, the residual quantity of the battery 9B, and other factors. Therefore, the output voltage of the battery 9B in some cases changes very little. In addition, as described previously, the output voltage of the battery 9B may vary depending on the environment in which the battery 9B is used, and other factors. This means that the behavior of the output voltage changes of the AC adapter 9A is more stable as compared to the output voltage of the battery 9B. That is, in the case of the AC adapter 9A, the specific behavior of the output voltage changes is exhibited more stably. Moreover, the output voltage itself of the AC adapter 9A is more stable. Thus, when it is determined whether or not the power source is the AC power source 9C on the basis of the behavior of the output voltage changes of the AC adapter 9A, the power source is determined with higher accuracy as compared to when it is determined whether or not the power source is the battery 9B on the basis of the behavior of the output voltage changes of the battery 9B.

### Other Embodiments

The present invention is not limited to the foregoing embodiment, but is also applicable to the following configurations.

In the foregoing embodiment, a digital camera is described as an example electronic device, however, the present invention is not limited thereto. The configuration described above is applicable to electronic devices other than digital cameras, for example, cell phones and portable audio devices.

In the foregoing embodiment, the power source is determined according to the behavior of the output voltage changes of the battery installation part 91 during the initialization operation of the mechanical shutter 23 and diaphragm 24. However, the present invention is not limited thereto. Specifically, the behavior of the output voltage changes of the battery installation part 91 monitored when operating members, such as the CCD image sensor 21, the liquid crystal monitor 70, and the strobe 92, are made to perform a given operation may also be used. That is, in making a determination as to the power source, power from the power source may be supplied to any operating member or members which are operated selectively in accordance with an operation of the digital camera 10.

Furthermore, in the foregoing embodiment, the power source is determined in accordance with the behavior of the output voltage changes of the battery installation part 91 during the initialization operation performed when power is turned on. However, the present invention is not limited thereto. The power source may be determined according to the behavior of the output voltage changes of the battery installation part 91 at the timing of other operation. In a case in which an interchangeable lens is attachable to and removable from the camera body, the other operation timing may be the timing of initialization operation performed when the interchangeable lens is attached, for example.

Moreover, the number of times determination as to the power source is made is not limited to one. During the above-described initialization operation, determination as to the power source may be made multiple times. This increases the reliability of determination. Also, the timing of the determination is not limited to during the initialization operation, but the determination as to the power source may be made multiple times by performing such power source determination at other timings as well.

Also, in the foregoing embodiment, it is determined whether or not the behavior of the output voltage changes exhibits an increase in accordance with the relationship between the values of the output voltages at the first and second times T1 and T2, thereby determining whether or not the power source is the AC power source 9C. Nevertheless, the present invention is not limited thereto. The detected output voltage may contain an error. Therefore, such an error may be taken into account when determining whether or not the behavior of the output voltage changes exhibits an increase. Specifically, determination as to the power source may be made as follows. When the relationship “(the output voltage at the second time T2)−(the output voltage at the first time T1)>α” is satisfied, the behavior of the output voltage changes exhibits an increase, and therefore it is determined that the power source is the AC power source 9C connected through the AC adapter 9A. When this conditional expression is not satisfied, the behavior of the output voltage changes does not exhibit an increase, and thus it is determined that the power source is the battery 9B. The determination value α is a value calculated considering such an error. To be specific, α is a value at least by which a detected voltage, even when containing an error, will increase if the power source is the AC power source 9C connected through the AC adapter 9A. The determination value α can be statistically obtained by actually measuring in advance a value calculated by subtracting “the output voltage at the first time T1” from “the output voltage at the second time T2” for both the AC power source 9C through the AC adapter 9A and the battery 9B. The determination value α is stored in the flash memory 41.

Furthermore, in the foregoing embodiment, it is determined whether or not the power source is the AC power source 9C on the basis of the behavior of the output voltage changes of the AC adapter 9A, thereby determining the power source. Nevertheless, the present invention is not limited thereto. Specifically, the power source may be determined by determining whether or not the power source is the battery 9B on the basis of the behavior of the output voltage changes of the battery 9B.

Also, in the foregoing embodiment, the non-battery power source is the AC power source 9C, but is not limited thereto.

Moreover, in the foregoing embodiment, a primary battery is used as the battery power source. However, not only a primary battery but also a secondary battery may be used as the battery power source, and various types of batteries may be used.

Furthermore, in the foregoing embodiment, the controller 50 samples the voltage from the power source during initialization operation, however, the present invention is not limited thereto. The controller 50 may also sample the voltage from the power source at times other than during initialization operation. Then, the start of initialization operation can be determined using the sampled voltage, because the load of the initialization operation causes a drop in the voltage. Hence, it is possible to determine the start of initialization operation with a simple configuration. Likewise, the completion of initialization operation can also be determined according to a change in the voltage.

Also, in the foregoing embodiment, the voltage output when the mechanical shutter 23 and the diaphragm 24 are both controlled is monitored. However, the present invention is not limited thereto. A voltage output when either the mechanical shutter 23 or the diaphragm 24 is controlled may also be monitored. In FIGS. 3(A) and 3(B), the voltages output during initialization operation are represented by sets of straight lines. These sets of straight lines schematically show the output voltages for easier understanding of the descriptions, and the actual measured voltages differ from those shown in the figures. For example, in the case of the AC adapter 9A, the voltage output from the power source during initialization operation increases in a quadratic fashion (the output voltage changes in a curve) due to the characteristics of the AC adapter 9A. In the case of the battery 9B, the voltage output from the power source during initialization operation decreases linearly (although this voltage decrease is not represented by a straight line in a strict sense).

As describe above, the present invention is applicable to electronic devices, for example, digital cameras, cell phones, and portable audio devices.

It should be noted that the present invention is in no way limited to the embodiments described herein, but may be embodied in various other forms without departing from the spirit or essential characteristics thereof. Therefore, the embodiments described herein are to be considered in all respects as illustrative and not restrictive, the scope of the invention being indicated by the appended claims rather than by the foregoing description. All modifications and changes that come within the meaning and range of equivalency of the claims are intended to be embraced therein.

What is claimed is:

1. An electronic device including a connection part to which either an AC adapter connected to a non-battery power source or a battery power source is selectively connected, the electronic device comprising:
an operating member;
a supply section configured to supply, to the operating member, power output through the connection part from either the AC adapter or the battery power source which is connected to the connection part;
a voltage monitoring section configured to monitor a voltage output through the connection part when the supply section supplies the power to the operating member; and
a determination section configured to determine whether the AC adapter or the battery power source is connected to the connection part, in accordance with a behavior of the voltage changes monitored by the voltage monitoring section.

2. The electronic device of claim 1, wherein the operating member is operated at least at startup of the electronic device; and
the determination section determines whether the AC adapter or the battery power source is connected to the connection part at startup of the electronic device.

3. The electronic device of claim 1, wherein the operating member is operated selectively in accordance with an operation of the electronic device; and
the determination section determines whether the AC adapter or the battery power source is connected to the connection part at the operating member being operated.

4. An electronic device including a connection part to which either an AC adapter connected to a non-battery power source or a battery power source is selectively connected, the electronic device comprising:
a first operating member;
a second operating member different from the first operating member;
a first supply section configured to supply, to the first operating member, power output through the connection part from either the AC adapter or the battery power source which is connected to the connection part;
a voltage monitoring section configured to monitor a voltage output through the connection part when the first supply section supplies the power to the first operating member;
a determination section configured to determine whether the AC adapter or the battery power source is connected to the connection part, in accordance with a behavior of the voltage changes monitored by the voltage monitoring section;
a second supply section configured to supply, to the second operating member, the power output through the connection part from either the AC adapter or the battery power source which is connected to the connection part; and
a control section configured to control the power supplied to the second operating member from the second supply section, in accordance with a determination result obtained by the determination section.

5. The electronic device of claim 4, wherein the determination section determines whether the AC adapter or the battery power source is connected to the connection part at startup of the electronic device.
